(19) United States
(12) Patent Application Publication
(10) Pub. No.: US 2026/0332373 A1
(43) Pub. Date: Oct. 22, 2026

(54) DEVICES AND METHODS FOR MONITORING PDCCH

(71) Applicant: Lenovo (Beijing) Limited, Beijing (CN)

(72) Inventors: Ruixiang Ma, Beijing (CN); Yuantao Zhang, Beijing (CN)

(73) Assignee: Lenovo (Beijing) Limited, Beijing (CN)

(21) Appl. No.: 19/482,697

(22) PCT Filed: May 11, 2023
(86) PCT No.: PCT/CN2023/093676

§ 371 Date: Nov. 7, 2025

(51) Int. Cl. H04L 5/14; H04L 5/00; H04W 72/232

(52) U.S. Cl. CPC H04L 5/14; H04L 5/0094; H04W 72/232

(57) ABSTRACT

Embodiments of the present disclosure relate to devices and methods for monitoring a PDCCH. In an aspect, a terminal device monitors, according to a first set of parameters, a PDCCH in a first occasion of an SS set i or in a first slot including the first occasion. The first occasion includes an SBFD symbol, and the first set of parameters is associated with the SS set i and is different from a second set of parameters of the SS set i. In this way, the terminal device could perform PDCCH monitoring in SBFD scenarios.

### FIELD

Embodiments of the present disclosure generally relate to the field of communication, and in particular to devices, methods, and a non-transitory computer readable medium for monitoring a physical downlink control channel (PDCCH), e.g., in a sub-band full duplex (SBFD) scenario.

### BACKGROUND

To realize the superior data rate and latency, 5^{th} generation (5G) spectrum on higher frequency band is inevitable. 3GPP Rel.18 will probably introduce a new duplexing scheme that enables simultaneous use of downlink and uplink within a time division duplex (TDD) carrier using non-overlapped frequency resource, which could be named as SBFD.

A set of PDCCH candidates for a user equipment (UE) to monitor is defined in terms of PDCCH scarch space (SS) sets. A search space set can be a common search space (CSS) set or a UE-specific search space (USS) set. A UE monitors PDCCH candidates in one or more search spaces sets. There is need for enhancements on PDCCH monitoring, e.g., in an SBFD scenario.

### SUMMARY

In general, example embodiments of the present disclosure provide devices, methods, and a non-transitory computer readable medium for monitoring a PDCCH, e.g., in an SBFD scenario.

In a first aspect, there is provided a terminal device. The terminal device comprises a processor and a transceiver coupled to the processor. The processor is configured to: monitor, via the transceiver and according to a first set of parameters, a PDCCH in a first occasion of a SS set i or in a first slot including the first occasion, wherein the first occasion includes an SBFD symbol, and the first set of parameters is associated with the SS set i and is different from a second set of parameters of the SS set i.

In a second aspect, there is provided a network device. The network device comprises a processor and a transceiver coupled to the processor. The processor is configured to: transmit, via the transceiver to a terminal device and according to a first set of parameters, a PDCCH in a first occasion of a SS set i or in a first slot including the first occasion, wherein the first occasion includes an SBFD symbol, and the first set of parameters is associated with the SS set i and is different from a second set of parameters of the SS set i.

In a third aspect, there is provided a method performed by a terminal device. The method comprises: monitoring, via the transceiver and according to a first set of parameters, a PDCCH in a first occasion of a SS set i or in a first slot including the first occasion, wherein the first occasion includes an SBFD symbol, and the first set of parameters is associated with the SS set i and is different from a second set of parameters of the SS set i.

In a fourth aspect, there is provided a method performed by a network device. The method comprises: transmitting, via the transceiver to a terminal device and according to a first set of parameters, a PDCCH in a first occasion of a SS set i or in a first slot including the first occasion, wherein the first occasion includes an SBFD symbol, and the first set of parameters is associated with the SS set i and is different from a second set of parameters of the SS set i.

In a fifth aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

In a sixth aspect, there is provided a computer program product. The computer program product comprises instructions. The instructions, when executed by a processor of an apparatus, causing the apparatus at least to perform the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates an example network environment in which some embodiments of the present disclosure can be implemented;

FIG. 1B illustrates an example diagram of PDCCII monitoring occasions of a SS set;

FIG. 1C illustrates an example diagram of an SS set i linked with an SS set j;

FIG. 1D illustrates an example diagram of an SBFD scheme;

FIG. 1E illustrates an example diagram of a scenario that an occasion of an SS set i is overlapped with a UL subband;

FIG. 2 illustrates an example signaling chart of an example process according to some embodiments of the present disclosure;

FIG. 3 illustrates an example diagram of an SS set j linked with an SS set i according to some embodiments of the present disclosure;

FIG. 4 illustrates an example diagram of an SS set k linked with an SS set i for a PDCCH repetition according to some embodiments of the present disclosure, wherein a PDCCH candidate in SS set k has no linked PDCCH candidate in SS set i;

FIG. 5 illustrates another example diagram of an SS set k linked with an SS set i for a PDCCH repetition according to some embodiments of the present disclosure, wherein all PDCCH candidates in both SS set i and SS set k are single PDCCH without a repetition in the DL_SBFD slot;

FIG. 6 illustrates another example diagram of an SS set k linked with an SS set i for a PDCCH repetition according to some embodiments of the present disclosure, wherein all PDCCII candidates in both SS set i and SS set k are single PDCCII without a repetition in an occasion overlapped with an SBFD symbol;

FIG. 7 illustrates another example diagram of an SS set k linked with an SS set i for a PDCCH repetition according to some embodiments of the present disclosure, wherein UE does not monitor the PDCCH candidate in SS set k without a linked PDCCH candidate in SS set i;

FIG. 8 illustrates another example diagram of an SS set k linked with an SS set i for a PDCCH repetition according to some embodiments of the present disclosure, wherein it is assumed that an occasion of SS set k not overlapping with an SBFD symbol is overlapped with an SBFD symbol;

FIG. 9 illustrates a flowchart of a method implemented at a terminal device according to some embodiments of the present disclosure;

FIG. 10 illustrates a flowchart of a method implemented at a network device according to some embodiments of the present disclosure; and

FIG. 11 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure.

The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s).

Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (M_{S}), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

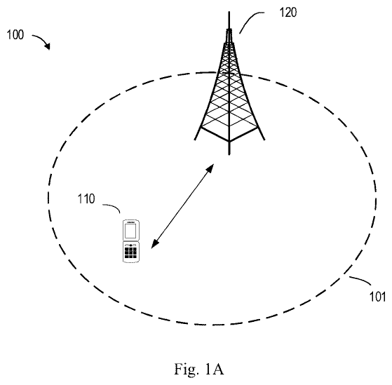

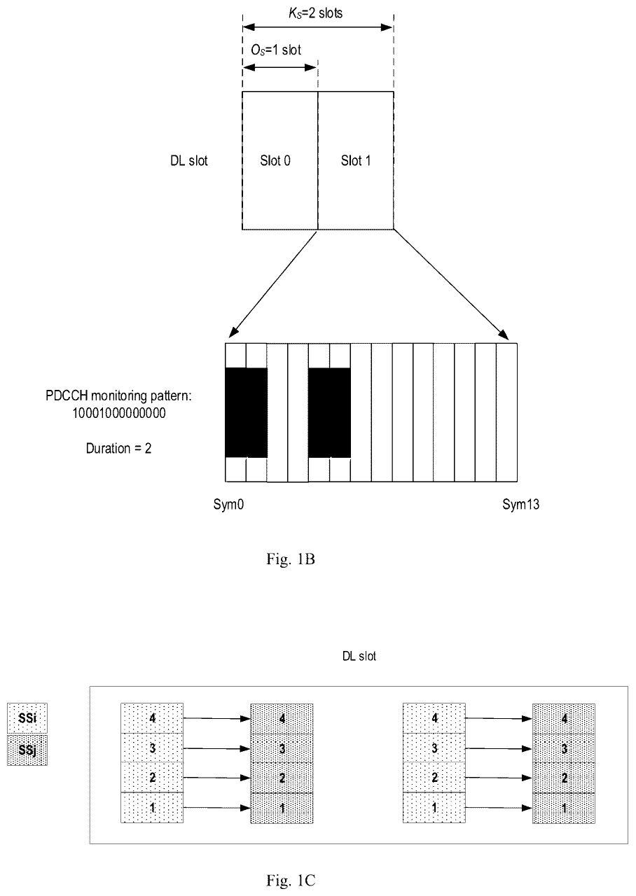

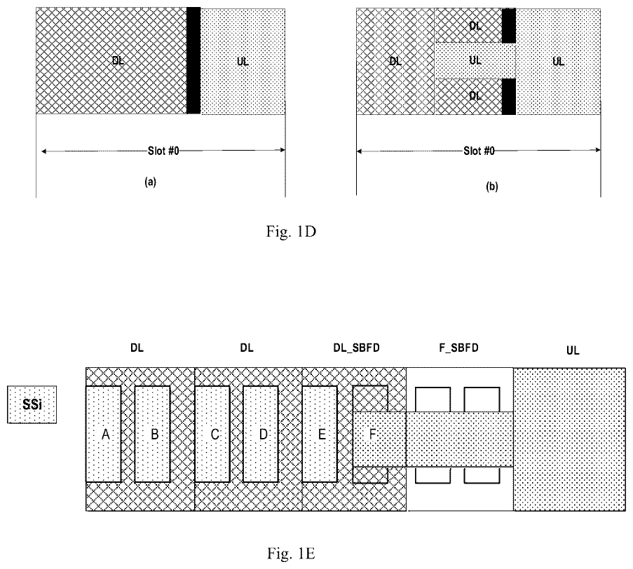

FIG. 1A illustrates an example network environment 100 in which example embodiments of the present disclosure may be implemented. The environment 100, which may be a part of a communication network, comprises terminal devices and network devices.

As illustrated in FIG. 1A, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

There would be multiple service types in new radio (NR) system, such as enhanced mobile broadband (eMBB), ultra-reliable low-latency communication (URLLC), machine-type communication (MTC) and so on.

A UE monitors PDCCH candidates in one or more search spaces sets. For each SS set, it could be associated with one control resource set (COREST), and UE could be configured with configured at most 4 CORESTs, and for each CORESET, UE could be configured the the UE is provided the following by ControlResourceSet:
a CORESET index p, by controlResourceSetld;
a number of consecutive symbols provided by duration;
a set of resource blocks provided by frequencyDomainResources.

Thus to say UE can determine the number of symbol, and the frequency domain location of a SS set according to the associated CORESET.

UE is provided by higher layers with S≤10 search space sets where, for each search space set from the S search space sets, the UE is provided the following by SearchSpace:
a search space set index s, 0<s<40, by searchSpaceId;
an association between the search space set s and a CORESET p by controlResourceSetId or by controlResourceSetId-v1610;
a PDCCH monitoring periodicity of kₛ slots and a PDCCH monitoring offset of oₛ slots, by monitoringSlotPeriodicity AndOffset or by monitoringSlotPeriodicityAndOffset-r17;
a PDCCH monitoring pattern within a slot, indicating first symbol(s) of the CORESET for PDCCH monitoring within each slot where the UE monitors PDCCH, by monitoringSymbolsWithinSlot;
a number of PDCCH candidates M^{(L)}ₛ per control channel element (CCE) aggregation level (AL) L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively.

A UE determines a PDCCH monitoring occasion on an active DL bandwidth part (BWP) from the PDCCH monitoring periodicity, the PDCCH monitoring offset, and the PDCCH monitoring pattern within a slot.

For example, SS set 1 is associated with CORESET 1, for CORESET 1, duration=2 is configured. And for SS set 1, the configured periodicity is kₛ=2 slots, and offset oₛ=1slot, and PDCCH monitoring pattern within a slot is 10001000000000, then the PDCCH monitoring occasion is determined as FIG. 1B. The frequency domain resource of each occasion is the frequency domain resource configured in the CORESET.

Aggregation level=L means that, a PDCCH candidate could occupy L CCE, and one CCE include 6RBs. For each PDCCH candidate of each AL, UE could determine the CCE index according to the following formula.

For a search space set s associated with CORESET p, the CCE indexes for aggregation
$Level L corresponding to PDCCH candidate {m}_{s , {n}_{CI}}^{( L )} of the search space set in slot {n}_{s , f}^{μ}$
for an active DL BWP of a serving cell corresponding to carrier indicator field value n_{CI} are given by
$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$
where
$for any CSS , {Y}_{p , {n}_{s , f}^{μ}} = 0 ;$
$for a USS , {Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827 for$
pmod3 = 0, Aₚ = 39829 for pmod3 = 1, Aₚ = 39839 for pmod3 = 2, and D = 65537;
i = 0, . . . , L − 1;
N_{CCE,p} is the number of CCEs, numbered from 0 to N_{CCE,p} − 1, in CORESET p and, if any, per RB set;
n_{CI} is the carrier indicator field value if the UE is configured with a carrier indicator field
by CrossCarrierSchedulingConfig for the serving cell on which PDCCH is monitored,
except for scheduling of the serving cell from the same serving cell in which case n_{CI} = 0;
otherwise, including for any CSS, n_{CI} = 0;
${m}_{s , {n}_{CI}}^{( L )} = 0 , … , {M}_{s , {n}_{CI}}^{( L )} - 1 , where {M}_{s , {n}_{CI}}^{( L )} is the number of PDCCII candidtates the UE is$
configured to monitor for aggregation level L of a search space set s for a serving cell
corresponding to n_{CI};
$for any CSS , {M}_{s , max}^{( L )} = {M}_{s , 0}^{( L )} ;$
$for a USS , {M}_{s , max}^{( L )} is the maximum of {M}_{s , {n}_{CI}}^{( L )} over all configured {n}_{CI} values for a CCE$
aggregation level L of search space set s;
the RNTI value used for N_{RNTI} is the C-RNTI.

For search space sets sᵢ and sⱼ that include searchSpaceLinking with value sᵢ and sᵢ, respectively, a UE monitors, in monitoring occasions with same index according to each of search space sets sᵢ and sⱼ in a slot, PDCCH candidates

$${m}_{{s}_{i} , {n}_{CI}}^{( L )} and {m}_{{s}_{j} , {n}_{CI}}^{( L )} , with {m}_{{s}_{i} , {n}_{CI}}^{( L )} and {m}_{{s}_{j} , {n}_{CI}}^{( L )} ,$$

for detection of a DCI format with same information. The UE expects kₛ_{ᵢ}=kₛ_{ⱼ}, oₛ_{ᵢ}=oₛ_{ⱼ}, Tₛ_{ᵢ}=Tₛ_{ⱼ},

$${M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ.

For example, in FIG. 1C, SS set i (which can be also referred to as SSi) is linked with SS set j (which can be also referred to as SSj), and for an AL, 4 candidates are configured for both SS set i and SS set j. They are linked one to one.

When a PDCCH reception by a UE includes two PDCCH candidates from corresponding search space sets,
a PDCCH monitoring occasion is the union of the PDCCH monitoring occasions for the two PDCCH candidates;
the start of the PDCCH reception is the start of the earlier PDCCH candidate;
the end of the PDCCH reception is the end of the PDCCH candidate that ends later.

As described above, to realize the superior data rate and latency, 5G spectrum on higher frequency band is inevitable. But a big question is how to overcome the coverage reduction on such carriers. 3GPP Rel.18 will probably introduce a new duplexing scheme that enables simultaneous use of downlink and uplink within a TDD carrier using non-overlapped frequency resource, which could be named as Sub-band full duplex. The intention of this scheme is to extend the duration over which uplink transmission could occur for improved the uplink coverage and capacity. The simultaneous use of DL and UL is only at gNB and not at UE side.

The example of SBFD scheme could be seen in FIG. 1D. Assuming the slot format for slot #0 determined according to tdd-UL-DL-ConfigCommon or tdd-UL-DL-ConfigurationDedicated or SFI is shown in (a), then there could be other signaling indicates the frequency domain resource and time domain resource of UL sub-band of SBFD, which can override the DL and/or flexible symbols or some of the DL and/or flexible symbols/slots, which could be shown in (b).

For a configured SS set, there would be a scenario that in a slot, one occasion of the SS set would be overlapped with the configured UL subband. FIG. 1E illustrates an example diagram of this scenario. As shown in FIG. 1E, the occasion F of the SS set i is overlapped with a UL subband. Then how to do the PDCCH monitoring in the occasion should be discussed.

It should be understood that, in embodiments of the present disclosure, an occasion of an SS set being overlapped with a UL subband means that a frequency resource of the occasion being overlapped with a UL subband. Or in other words, the associated CORESET of the SS set is overlapped with UL subband in the occasion.

In view of the above and other aspects, embodiments of the present disclosure provide solutions for PDCCH monitoring in SBFD scenarios. In the solutions, a terminal device can monitor the PDCCH in an occasion of a SS set, where the occasion is overlapped with a UL subband. In an aspect of the solutions of the present disclosure, a terminal device may monitor, according to a first set of parameters, a PDCCH in a first occasion of an SS set i or in a first slot including the first occasion. The first occasion includes an SBFD symbol, and the first set of parameters is associated with the SS set i and is different from a second set of parameters of the SS set i.

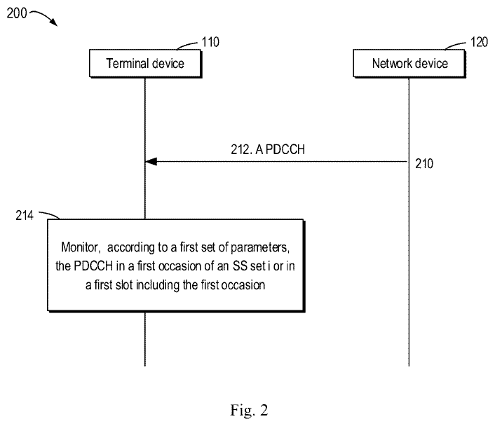

Principles and implementations of embodiments of the present disclosure will be described in detail below with reference to FIGS. 2-10.

### EXAMPLE METHOD

FIG. 2 illustrates an example signaling chart illustrating an example process 200 according to some embodiments of the present disclosure. For the purpose of discussion, the example 200 will be described with reference to FIG. 1A, and the process 200 may involve the terminal device 110 and the network device 120 as shown in FIG. 1A.

As shown in FIG. 2, the network device 120 may transmit 210, according to a first set of parameters, a PDCCH 212 in a first occasion of a SS set i or in a first slot including the first occasion. The first occasion includes a SBFD symbol, and the first set of parameters is associated with the SS set i and is different from a second set of parameters of the SS set i.

The terminal device 110 monitors 214, according to the first set of parameters, the PDCCH in the first occasion of the SS set i or in the first slot including the first occasion.

By way of example without making any limitations, the parameters could be one or more of the following:
a search space set index s, 0<s<40, by searchSpaceld;
an association between the search space set s and a CORESET p by controlResourceSetId or by controlResourceSetld-v1610;
a PDCCH monitoring periodicity of kₛ slots and a PDCCH monitoring offset of oₛ slots;
a PDCCH monitoring pattern within a slot;
a number of PDCCH candidates Mₛ^{(L)} per CCE aggregation level L by
aggregationLevel1, aggregationLevel2, aggregationLevel4, aggregationLevel8, and
aggregationLevel16, for CCE aggregation level 1, CCE aggregation level 2, CCE
aggregation level 4, CCE aggregation level 8, and CCE aggregation level 16, respectively.

It should be understood that the parameters could be other parameters suitable for using to perform PDCCH monitoring in SBFD scenarios.

An associated CORESET of the SS set i may be outside a DL subband or overlapped with a UL subband. In some embodiments, the terminal device 110 may monitor, according to a second set of parameters, the PDCCH in a second occasion of the SS set i or in a second slot including the second occasion. The second occasion does not include the SBFD symbol.

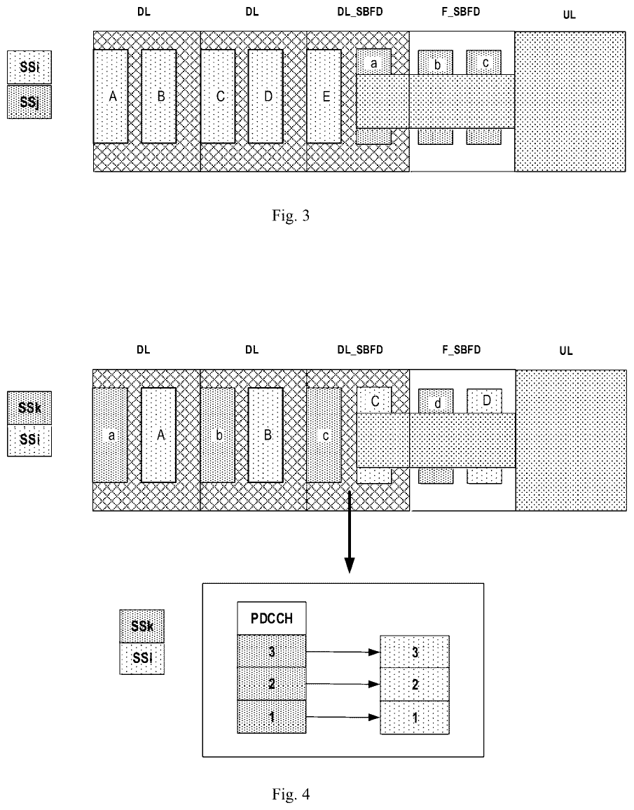

Some exemplary solutions for PDCCH monitoring in SBFD scenarios will be described in details below. In the scenarios, UE may determine multiple monitoring occasion of SS set i associated with a CORESET, and a monitoring occasion may be overlapped with configured UL subband in slot 1, e.g., in the DL_SBFD slot as shown in FIGS. 3-5.

Basically, UE does not expect a PDCCH monitoring occasion overlapped with both SBFD symbol and non-SBFD symbol. UE does not monitor the PDCCH candidate in the occasion if the occasion is overlapped with both SBFD symbol and non-SBFD symbol. UE may drop the SS in the occasion if the occasion is overlapped with both SBFD symbol and non-SBFD symbol.

In an exemplary solution for PDCCH monitoring in SBFD scenarios, SS set i can be linked with SS set j by a higher layer signalling, wherein, SS set i is for monitoring a PDCCH in one or more occasions or slots that do not include SBFD symbol(s), SS set j is for monitoring the PDCCH in one or more occasions or slots including SBFD symbol(s). UE determines to monitor the PDCCH in SS set j and not monitor PDCCH in SS set i in the occasion overlapped with the UL subband or in slot 1 including the occasion.

The UE and network device need to know which one of the linked SS sets is for SBFD or non-SBFD. This could be predefined. For example, the linked SS set with the smaller or lager index may be for non-SBFD.

To link the SS sets, for SS set i, an index of j can be configured to indicate the associated SS set. The UE expects that kₛ_{ᵢ}=kₛ_{ⱼ}, oₛ_{ᵢ}=oₛ_{ⱼ}, Tₛ_{ᵢ}=Tₛ_{ⱼ}

$${M}_{{s}_{i}}^{( L )} = {M}_{{s}_{j}}^{( L )} ,$$

and a same PDCCH monitoring pattern is configured for SS set i and SS set j.

FIG. 3 illustrates an example diagram of the SS set i linked with the SS set j. As shown in FIG. 3, the SS set j is configured for an SBFD symbol or slot, and thus occasions a, b and c of the SS set j are not overlapped with the UL subband. Therefore, in the case that the SS set j is for an SBFD symbol, in occasions A, B, C, D and E, UE can monitor the PDCCH using the SS set i, and in occasions a, b and c, UE can monitor the PDCCH using the SS set j. Alternatively, UE can monitor the PDCCH in the DL slots using the SS set i, and monitor the PDCCH in the slot including SBFD symbols using the SS set j.

UE may determine the linked SS sets are for a PDCCH repetition or for a PDCCH transmission in SBFD/non-SBFD symbols based a higher layer signalling, or based on whether the PDCCH monitoring pattern is same or not.

In another exemplary solution for PDCCH monitoring in SBFD scenarios, one or more dedicated SS sets may be configured for an SBFD symbol or slot. In the slot with an SBFD symbol, one of the one or more dedicated SS sets can be used for PDCCH monitoring. The dedicated SS may be not configured with a periodicity or offset; it may be appeared in each slot with an SBFD symbol.

In another exemplary solution for PDCCH monitoring in SBFD scenarios, different valid resources for the CORESET in SBFD symbols and non-SBFD symbols can be determined. For example, the resource overlapped with a UL subband is invalid. UE monitors PDCCH in the valid resource in the occasion. Alternatively, UE monitors PDCCH in the valid resource in the slot including the occasion.

In a case, for SS set i, for each AL, two numbers of PDCCH candidates can be configured. Alternatively, two sets of ALs and corresponding numbers of PDCCH candidates for each AL in each set can be configured. One set is for SBFD symbols, and the other is for non-SBFD symbols. UE monitors PDCCH using the AL and candidate parameter for SBFD symbols. For example, using different parameters to calculate the CCE index for a PDCCH candidate in different occasion.

In another case, in this occasion or slot, to calculate the CCE index for a PDCCH candidate with AL=L, M can be equal to min

$$\{ {M}_{s , {n}_{CI}}^{( L )} , N / L \}$$

in the following formula, wherein N can be equal to the number of CCE in the region, e.g., in the occasion or slot.

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i .$$

In another exemplary solution for PDCCH monitoring in SBFD scenarios, it may apply that rate matching or puncturing on one or more resource elements groups (REGs) of a PDCCH outside DL subband(s).

For example, if a PDCCH candidate with AL=L is in CCE i to CCE L+i−1, wherein one CCE is mapping to a REG bundle and a REG bundle include 6 REG, and if for CCE k, some REGs are outside a DL subband or overlapped with a UL subband, then the PDCCH can be transmitted in the remaining REGs, or the PDCCH can be transmitted in the remaining CCEs or transmitted in N CCEs, N is equal to or smaller than L and is the largest one from {1,2,4,8,16}; if L=1, then the PDCCH is cancelled.

The CCE with a REG overlapped with a UL subband or outside a DL subband can be not counted in the non-overlapping CCEs for PDCCH monitoring.

Some solutions for PDCCII monitoring in SBFD scenarios are described above by way of example. In some embodiments, if SS set i is also linked with SS set k for a PDCCH repetition, UE does not expect that SS set i is in SBFD symbols but SS set k is in non-SBFD symbols for a same monitoring occasion.

Then, there would be a case that, in a slot, a same occasion index, one SS is in SBFD symbols, and the other is in normal symbols, as shown in FIGS. 4-8. Then the number of candidates for an AL would be different considering different numbers of CCEs could be used for the occasion index. For example, PDCCH candidate 4 (e.g., the block “PDCCH” as shown in FIG. 4) in SS set k could not find the linked PDCCH candidate in SS set i. FIG. 4 illustrates an example diagram of an SS set k linked with an SS set i for a PDCCH repetition, wherein a PDCCH candidate in SS set k has no linked PDCCH candidate in SS set i.

In this case, the following methods could be used. In embodiments of the present disclosure, if an occasion of an SS set includes an SBFD symbol and an associated CORESET of the SS set is outside a DL subband or overlapped with a UL subband, the occasion can be referred to as an overlapped occasion; a slot including the overlapped occasion can be referred to as an overlapped slot.

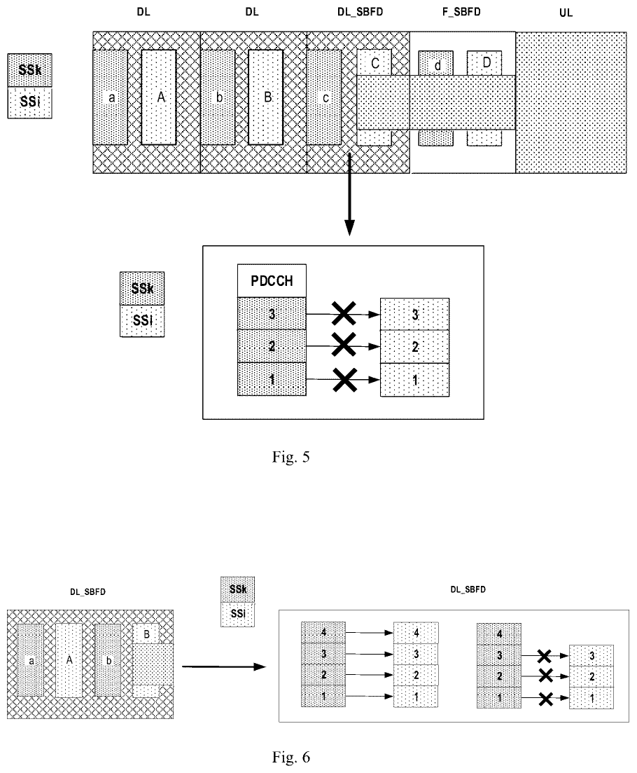

In an exemplary method, all PDCCH candidates in both SS set i and SS set k can be single PDCCH without a repetition in the overlapped slot. As shown in FIG. 5, the PDCCH candidates in SS set i and in SS set k in the DL_SBFD slot can be single PDCCH without a repetition. For example, the PDCCH candidates 1, 2, 3 in the occasion c of SS set k are not linked with the PDCCH candidates 1, 2, 3 in the occasion C of SS set i.

In another exemplary method, UE does not monitor PDCCH in all occasions of SS set i and SS set k in the overlapped slot.

In another exemplary method, all PDCCH candidates in both SS set i and SS set k can be single PDCCH without a repetition in the overlapped occasion. For example, as shown in FIG. 6, in the DL_SBDF slot (DL slot including SBFD symbol), the PDCCH candidates 1, 2, 3, 4 in the occasion a of SS set k are linked with the PDCCH candidates 1, 2, 3, 4 in the occasion A of SS set i; the PDCCH candidates 1, 2, 3, 4 in the occasion b of SS set k are not linked with the PDCCH candidates 1, 2, 3 in the occasion B of SS set i. The PDCCH candidates 1, 2, 3, 4 in the occasion b and the PDCCH candidates 1, 2, 3 in the occasion B are single PDCCHs without a repetition.

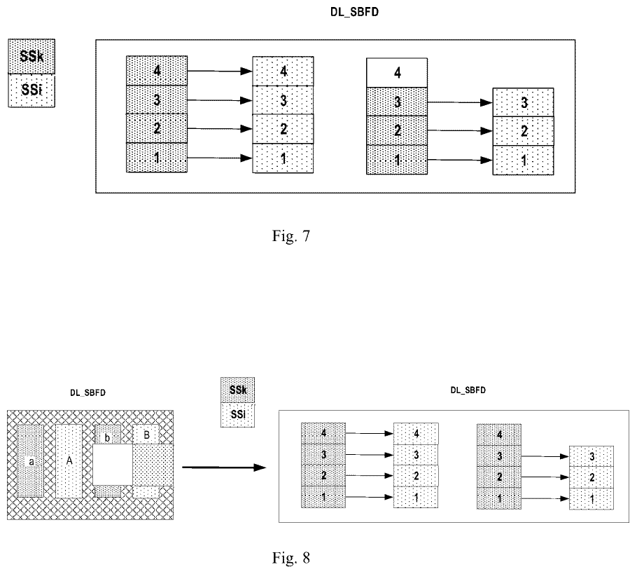

In another exemplary method, UE does not monitor the PDCCH candidate i for AL 1 in SS set k in an occasion, if there is no PDCCH candidate i for AL 1 in SS set i in the associated occasion, wherein SS set k and SS set i arc linked. For example, as shown in FIG. 7, the PDCCH candidate 4 (in white block) for AL 1 in SS set k has no linked PDCCH candidate for AL 1 in SS set i in the associated occasion, and thus UE does not monitor the PDCCH candidate 4 (in white block) in SS set k.

In another exemplary method, UE monitors a PDCCH in the PDCCH candidate i assuming it is without repetition.

In another exemplary method, for SS set k, also assuming it is overlapped with an SBFD symbol to do PDCCH monitoring. For example, as shown in FIG. 8, the occasion B in SS set i is overlapped with an SBFD symbol, while the occasion b in SS set k is actually not overlapped with an SBFD symbol. But it is assumed that the occasion b in SS set k is overlapped with an SBFD symbol to do PDCCH monitoring.

In another exemplary method, UE does not monitor SS set i in the overlapped occasion, but assuming the PDCCH monitored in SS k is repeated. The PDCCH reception still includes the two PDCCH candidates.

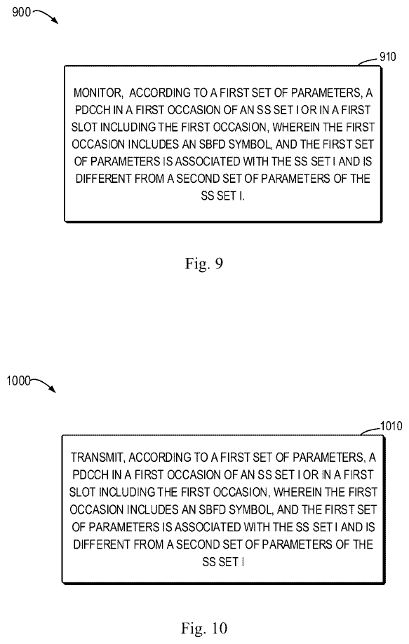

FIG. 9 illustrates a flowchart of a method 900 implemented at a terminal device according to some embodiments of the present disclosure. In some embodiments, the method 900 can be implemented at a communication device, such as the terminal device 110 as shown in FIG. 1A. In some other embodiments, the method 900 may be implemented at devices not shown in FIG. 1A. Further, it is to be understood that the method 900 may include additional blocks not shown and/or may omit some blocks as shown, and the scope of the present disclosure is not limited in this regard. For the purpose of discussion, the method 900 will be described from the perspective of the terminal device 110 with reference to FIG. 1A and FIG. 2.

At block 910, the terminal device 110 monitors, according to a first set of parameters, a PDCCH in a first occasion of an SS set i or in a first slot including the first occasion. The first occasion includes an SBFD symbol, and the first set of parameters is associated with the SS set i and is different from a second set of parameters of the SS set i.

In some embodiments, an associated CORESET of the SS set i is outside a DL subband or overlapped with a UL subband.

In some embodiments, the terminal device 110 may monitor, according to the second set of parameters, the PDCCH in a second occasion of the SS set i or in a second slot including the second occasion. The second occasion may do not include the SBFD symbol.

In some embodiments, the terminal device 110 may determine a SS set j linked with the SS set i. The SS set j may be used for monitoring the PDCCH in one or more occasions or slots including the SBFD symbol. Moreover, the first set of parameters is parameters of the SS set j.

In some embodiments, the terminal device 110 may skip monitoring the PDCCII in the SS set i in the first occasion or in the first slot. That is, the terminal device 110 may do not monitor the PDCCH in the SS set i in the first occasion or in the first slot. Moreover, the terminal device 110 may monitor, according to the first set of parameters, the PDCCH in the SS set j in an occasion of the SS set j or in the first slot. In some embodiments, the SS set i and the SS set j may have the same PDCCH monitoring pattern.

In some embodiments, the terminal device 110 may determine the SS set i to be used for monitoring the PDCCH in one or more occasions or slots including no SBFD symbol, and determine the SS set j to be used for monitoring the PDCCH in one or more occasions or slots including an SBFD symbol based on signalling from a network device.

In some embodiments, the terminal device 110 may determine one or more dedicated SS set j for monitoring the PDCCH in one or more occasions or slots including the SBFD symbol. The SS set j could be configured without a periodicity or offset. The first set of parameters is parameters of the SS set j. In this case, the terminal device 110 may skip monitoring the PDCCH in the SS set i in the first slot. That is, the terminal device 110 may do not monitor the PDCCII in the SS set i in the first slot. Moreover, the terminal device 110 may monitor, according to the first set of parameters, the PDCCII in the SS set j in the first slot.

In some embodiments, for an AL of the PDCCH, the first set of parameters may comprise a first number of PDCCH candidates for an SBFD symbol or slot, and the second set of parameter may comprise a second number of PDCCH candidates for a non-SBFD symbol or slot. Alternatively, the first set of parameters may comprise a first AL and a corresponding first number of PDCCH candidates for an SBFD symbol or slot, the second set of parameter may comprise a second AL and a corresponding second number of PDCCH candidates for a non-SBFD symbol or slot.

In some embodiments, the first number of PDCCH candidates for an SBFD symbol or slot may be determined based on a higher layer signaling from the network device 120. Alternatively, the first number of PDCCH candidates for an SBFD symbol or slot may be determined based on the second number of PDCCH candidates, a number of CCEs detected in the first occasion or in the first slot, and the second AL.

In some embodiments, the first set of parameters may comprise a first number of CCEs without a REG outside a DL subband or overlapped with a UL subband for a PDCCH candidate in the occasion. Alternatively, the first set of parameters may comprise a second number of CCEs that is biggest one from {1,2,4,8,16} and equal to or smaller than the first number of CCEs. In some embodiments, the terminal device 110 may monitor the PDCCH in the first number of CCEs or the second number of CCEs. In some embodiments, a CCE with an REG outside a DL subband or overlapped with a UL subband is not counted in non-overlapping CCEs for monitoring the PDCCH.

In some embodiments, a SS set k may be linked with the SS set i for a PDCCH repetition, and the first occasion of the SS set i may be linked with a third occasion of the SS set k including no SBFD symbol.

In some embodiments, the terminal device 110 may skip monitoring (i.e., do not monitor) the PDCCH in the third occasion of the SS set k. Alternatively or in addition, the terminal device 110 may skip monitoring the PDCCH in the SS set k in the first slot. Alternatively or in addition, the terminal device 110 may skip monitoring the PDCCH in the SS set k in a PDCCH candidate without a linked PDCCH candidate in the SS set i.

In some embodiments, the terminal device 110 may monitor, as a single PDCCH transmission without the PDCCH repetition, the PDCCH in the third occasion of the SS set k. Alternatively or in addition, the terminal device 110 may monitor, as a single PDCCH transmission without the PDCCH repetition, the PDCCH in the SS set k in the first slot. Alternatively or in addition, the terminal device 110 may monitor, as a single PDCCH transmission without the PDCCH repetition, the PDCCH in the SS set k in a PDCCH candidate without a linked PDCCH candidate repetition in the SS set i.

In some embodiments, the terminal device 110 may process the PDCCH assuming that the third occasion of the SS set k includes an SBFD symbol. In some embodiments, the terminal device 110 may skip monitoring the PDCCH in the SS set i in the first occasion, and monitor the PDCCH in the third occasion of the SS set k. Moreover, the terminal device 110 may process the PDCCH assuming that a PDCCH candidate in the third occasion of the SS set k has a linked PDCCH candidate repetition in the first occasion.

In some embodiments, the terminal device 110 may receive, from the network device 120, signaling indicating occasions of one or more SS sets. None of the occasions of the one or more SS set is overlapped with both an SBFD symbol and a non-SBFD symbol.

In some embodiments, the terminal device 110 may receive, from the network device 120, signaling indicating occasions of one or more SS sets. In the case that a fourth occasion in an SS set h among the one or more SS set is overlapped with both an SBFD symbol and a non-SBFD symbol, the terminal device 110 may skip monitoring the PDCCH in the fourth occasion of the SS set h or skip monitoring the PDCCH in the SS set h in the slot including the fourth occasion.

FIG. 10 illustrates a flowchart of a method 1000 implemented at a network device according to some embodiments of the present disclosure. In some embodiments, the method 1000 can be implemented at a communication device, such as the network device 120 as shown in FIG. 1A. In some other embodiments, the method 1000 may be implemented at devices not shown in FIG. 1A. Further, it is to be understood that the method 1000 may include additional blocks not shown and/or may omit some blocks as shown, and the scope of the present disclosure is not limited in this regard. For the purpose of discussion, the method 1000 will be described from the perspective of the network device 120 with reference to FIG. 1A and FIG. 2.

At block 1010, the network device 120 transmits, to the terminal device 110 and according to a first set of parameters, a PDCCII in a first occasion of an SS set i or in a first slot including the first occasion. The first occasion includes an SBFD symbol, and the first set of parameters is associated with the SS set i and is different from a second set of parameters of the SS set i.

In some embodiments, an associated CORESET of the SS set i may be outside a DL subband or overlapped with a UL subband.

In some embodiments, the network device 120 may transmit, according to the second set of parameters, the PDCCH in a second occasion of the SS set i or in a second slot including the second occasion. The second occasion may do not include the SBFD symbol.

In some embodiments, the network device 120 may determine a SS set j linked with the SS set i. The SS set j may be used for monitoring the PDCCH in one or more occasions or slots including the SBFD symbol, and the first set of parameters is parameters of the SS set j.

In some embodiments, the network device 120 may do not (e.g., skip) transmit the PDCCH in the SS set i in the first occasion or in the first slot. Moreover, the network device 120 may transmit, according to the first set of parameters, the PDCCH in the SS set j in an occasion of the SS set j or in the first slot. In some embodiments, the SS set i and the SS set j may have the same PDCCH monitoring pattern.

In some embodiments, the network device 120 may transmit, to the terminal device 110, signalling indicating that the SS set i is for monitoring the PDCCH in one or more occasions or slots including no SBFD symbol and that the SS set j is for monitoring the PDCCH in one or more occasions or slots including an SBFD symbol.

In some embodiments, the network device 120 may determine one or more dedicated SS set j for monitoring the PDCCH in one or more occasions or slots including the SBFD symbol. The SS set j could be configured without a periodicity or offset. The first set of parameters is parameters of the SS set j. In this case, the network device 120 may do not transmit the PDCCH in the SS set i in the first slot. Moreover, the network device 120 may transmit, according to the first set of parameters, the PDCCH in the SS set j in the first slot.

In some embodiments, for an AL of the PDCCH, the first set of parameters may comprise a first number of PDCCH candidates for an SBFD symbol or slot, and the second set of parameter may comprise a second number of PDCCII candidates for a non-SBFD symbol or slot. Alternatively, the first set of parameters may comprise a first AL and a corresponding first number of PDCCH candidates for an SBFD symbol or slot, the second set of parameter may comprise a second AL and a corresponding second number of PDCCH candidates for a non-SBFD symbol or slot.

In some embodiments, the first number of PDCCH candidates for an SBFD symbol or slot may be determined based on a higher layer signaling. Alternatively, the first number of PDCCH candidates for an SBFD symbol or slot may be determined based on the second number of PDCCH candidates, a number of CCEs detected in the first occasion or in the first slot, and the second AL.

In some embodiments, the first set of parameters may comprise a first number of CCEs without a REG outside a DL subband or overlapped with a UL subband for a PDCCH candidate in the occasion. Alternatively, the first set of parameters may comprise a second number of CCEs that is biggest one from {1,2,4,8,16} and equal to or smaller than the first number of CCEs.

In some embodiments, a SS set k may be linked with the SS set i for a PDCCH repetition, and the first occasion of the SS set i may be linked with a third occasion of the SS set k including no SBFD symbol.

In some embodiments, the network device 120 may do not transmit (e.g., skip transmitting) the PDCCH in the third occasion of the SS set k. Alternatively or in addition, the network device 120 may do not transmit the PDCCH in the SS set k in the first slot. Alternatively or in addition, the network device 120 may do not transmit the PDCCH in the SS set k in a PDCCH candidate without a linked PDCCH candidate in the SS set i.

In some embodiments, the network device 120 may transmit, as a single PDCCH transmission without the PDCCH repetition, the PDCCH in the third occasion of the SS set k. Alternatively or in addition, the network device 120 may transmit, as a single PDCCH transmission without the PDCCH repetition, the PDCCH in the SS set k in the first slot. Alternatively or in addition, the network device 120 may transmit, as a single PDCCH transmission without the PDCCH repetition, the PDCCH in the SS set k in a PDCCH candidate without a linked PDCCH candidate repetition in the SS set i.

In some embodiments, the network device 120 may transmit, to the terminal device 110, signaling indicating occasions of one or more SS sets. None of the occasions of the one or more SS set is overlapped with both an SBFD symbol and a non-SBFD symbol.

In some embodiments, the network device 120 may transmit, to the terminal device 110, signaling indicating occasions of one or more SS sets. In the case that a fourth occasion in an SS set h among the one or more SS set is overlapped with both an SBFD symbol and a non-SBFD symbol, the network device 120 may do not transmit the PDCCH in the fourth occasion of the SS set h or skip monitoring the PDCCH in the SS set h in the slot including the fourth occasion.

### EXAMPLE APPARATUS

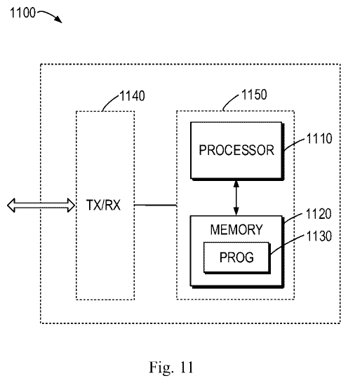

FIG. 11 illustrates a simplified block diagram of a device 1100 that is suitable for implementing embodiments of the present disclosure. The device 1100 can be considered as a further example implementation of the terminal device 110, and the network device 120 as shown in FIG. 1A. Accordingly, the device 1100 can be implemented at or as at least a part of the terminal device 110 or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, SI interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 1130 is assumed to include program instructions that, when executed by the associated processor 1110, enable the device 1100 to operate in accordance with the embodiments of the present disclosure, as discussed herein with reference to FIG. 1A to FIG. 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The embodiments of the present disclosure may further be described using the following clauses.

Clause 1. A terminal device comprising: a processor; and a transceiver coupled to the processor, wherein the processor is configured to: monitor, via the transceiver and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

Clause 2. The terminal device of clause 1, wherein an associated control resource set (CORESET) of the SS set i is outside a downlink (DL) subband or overlapped with an uplink (UL) subband.

Clause 3. The terminal device of clause 1, wherein the processor is further configured to: monitor, via the transceiver according to the second set of parameters, the PDCCH in a second occasion of the SS set i or in a second slot including the second occasion, wherein the second occasion does not include the SBFD symbol.

Clause 4. The terminal device of clause 1, wherein the processor is further configured to: determine a SS set j linked with the SS set i, wherein the SS set j is used for monitoring the PDCCH in one or more occasions or slots including the SBFD symbol, and the first set of parameters is parameters of the SS set j.

Clause 5. The terminal device of clause 4, wherein the processor is configured to monitor the PDCCH by: skipping monitoring the PDCCH in the SS set i in the first occasion or in the first slot; and monitoring, according to the first set of parameters, the PDCCH in the SS set j in an occasion of the SS set j or in the first slot.

Clause 6. The terminal device of clause 4, wherein the SS set i and the SS set j have the same PDCCH monitoring pattern.

Clause 7. The terminal device of clause 4, wherein the processor is further configured to: determine the SS set i to be used for monitoring the PDCCH in one or more occasions or slots including no SBFD symbol; and determine the SS set j to be used for monitoring the PDCCH in one or more occasions or slots including an SBFD symbol based on signalling from a network device.

Clause 8. The terminal device of clause 1, wherein the processor is further configured to: determine one or more dedicated SS set j for monitoring the PDCCH in one or more occasions or slots including the SBFD symbol, wherein the first set of parameters is parameters of the SS set j.

Clause 9. The terminal device of clause 8, wherein the processor is configured to monitor the PDCCH by: skipping monitoring the PDCCH in the SS set i in the first slot;
and monitoring, according to the first set of parameters, the PDCCH in the SS set j in the first slot.

Clause 10. The terminal device of clause 1, wherein one of the following: for an aggregation level (AL) of the PDCCH, the first set of parameters comprises a first number of PDCCH candidates for an SBFD symbol or slot, and the second set of parameter comprises a second number of PDCCH candidates for a non-SBFD symbol or slot; or the first set of parameters comprises a first AL and a corresponding first number of PDCCH candidates for an SBFD symbol or slot, the second set of parameter comprises a second AL and a corresponding second number of PDCCH candidates for a non-SBFD symbol or slot.

Clause 11. The terminal device of clause 10, wherein the first number of PDCCH candidates for an SBFD symbol or slot is determined based on one of the following: a higher layer signaling from a network device; or the second number of PDCCH candidates, a number of control channel elements (CCEs) detected in the first occasion or in the first slot, and the second AL.

Clause 12. The terminal device of clause 1, wherein the first set of parameters comprises one of the following: a first number of CCEs without a resource element group (REG) outside a DL subband or overlapped with a UL subband for a PDCCH candidate in the occasion; or a second number of CCEs that is biggest one from {1,2,4,8,16} and equal to or smaller than the first number of CCEs.

Clause 13. The terminal device of any of clauses 1-12, wherein a SS set k is linked with the SS set i for a PDCCII repetition, and the first occasion of the SS set i is linked with a third occasion of the SS set k including no SBFD symbol.

Clause 14. The terminal device of clause 13, wherein the processor is further configured to at least one of the following: skip monitoring the PDCCH in the third occasion of the SS set k; skip monitoring the PDCCH in the SS set k in the first slot; or skip monitoring the PDCCH in the SS set k in a PDCCH candidate without a linked PDCCH candidate in the SS set i.

Clause 15. The terminal device of clause 13, wherein the processor is further configured to at least one of the following: monitor, as a single PDCCH transmission without the PDCCH repetition, the PDCCH in the third occasion of the SS set k; monitor, as a single PDCCH transmission without the PDCCH repetition, the PDCCH in the SS set k in the first slot; or monitor, as a single PDCCH transmission without the PDCCH repetition, the PDCCH in the SS set k in a PDCCH candidate without a linked PDCCH candidate repetition in the SS set i.

Clause 16. The terminal device of clause 13, wherein the processor is further configured to: process the PDCCH assuming that the third occasion of the SS set k includes an SBFD symbol.

Clause 17. The terminal device of clause 13, wherein the processor is further configured to: skip monitoring the PDCCH in the SS set i in the first occasion; monitor the PDCCH in the third occasion of the SS set k; and process the PDCCH assuming that a PDCCH candidate in the third occasion of the SS set k has a linked PDCCH candidate repetition in the first occasion.

Clause 18. The terminal device of clause 1, wherein the processor is further configured to: receive, from the network device, signaling indicating occasions of one or more SS sets, wherein none of the occasions of the one or more SS set is overlapped with both an SBFD symbol and a non-SBFD symbol.

Clause 19. The terminal device of clause 1, wherein the processor is further configured to: receive, from the network device, signaling indicating occasions of one or more SS sets; and in the case that a fourth occasion in an SS set h among the one or more SS set is overlapped with both an SBFD symbol and a non-SBFD symbol, skip monitoring the PDCCH in the fourth occasion of the SS set h or skip monitoring the PDCCH in the SS set h in the slot including the fourth occasion.

Clause 20. A network device comprising: a processor; and a transceiver coupled to the processor, wherein the processor is configured to: transmit, via the transceiver to a terminal device and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

Clause 21. The network device of clause 20, wherein an associated control resource set (CORESET) of the SS set i is outside a downlink (DL) subband or overlapped with an uplink (UL) subband.

Clause 22. The network device of clause 20, wherein the processor is further configured to: transmit, via the transceiver according to the second set of parameters, the PDCCH in a second occasion of the SS set i or in a second slot including the second occasion, wherein the second occasion does not include the SBFD symbol.

Clause 23. The network device of clause 20, wherein the processor is further configured to: determine a SS set j linked with the SS set i, wherein the SS set j is used for monitoring the PDCCH in one or more occasions or slots including the SBFD symbol, and the first set of parameters is parameters of the SS set j.

Clause 24. The network device of clause 23, wherein the processor is configured to monitor the PDCCH by: skipping transmitting the PDCCH in the SS set i in the first occasion or in the first slot; and transmitting, according to the first set of parameters, the PDCCH in the SS set j in an occasion of the SS set j or in the first slot.

Clause 25. The network device of clause 23, wherein the SS set i and the SS set j have the same PDCCH monitoring pattern.

Clause 26. The network device of clause 23, wherein the processor is further configured to: transmit, to the terminal device, signalling indicating that the SS set i is for monitoring the PDCCH in one or more occasions or slots including no SBFD symbol and the SS set j is for monitoring the PDCCH in one or more occasions or slots including an SBFD symbol.

Clause 27. The network device of clause 20, wherein the processor is further configured to: determine one or more dedicated SS set j for monitoring the PDCCH in one or more occasions or slots including the SBFD symbol, wherein the first set of parameters is parameters of the SS set j.

Clause 28. The network device of clause 27, wherein the processor is configured to transmit the PDCCH by: skipping transmitting the PDCCH in the SS set i in the first slot; and transmitting, according to the first set of parameters, the PDCCH in the SS set j in the first slot.

Clause 29. The network device of clause 20, wherein one of the following: for an aggregation level (AL) of the PDCCH, the first set of parameters comprises a first number of PDCCH candidates for an SBFD symbol or slot, and the second set of parameter comprises a second number of PDCCH candidates for a non-SBFD symbol or slot; or the first set of parameters comprises a first AL and a corresponding first number of PDCCH candidates for an SBFD symbol or slot, the second set of parameter comprises a second AL and a corresponding second number of PDCCH candidates for a non-SBFD symbol or slot.

Clause 30. The network device of clause 29, wherein the first number of PDCCH candidates for an SBFD symbol or slot is determined based on one of the following: a higher layer signaling; or the second number of PDCCH candidates, a number of control channel elements (CCEs) detected in the first occasion or in the first slot, and the second AL.

Clause 31. The network device of clause 20, wherein the first set of parameters comprises one of the following: a first number of CCEs without a resource element group (REG) outside a DL subband or overlapped with a UL subband for a PDCCH candidate in the occasion; or a second number of CCEs that is biggest one from {1,2,4,8,16} and equal to or smaller than the first number of CCEs.

Clause 32. The network device of any of clauses 20-31, wherein a SS set k is linked with the SS set i for a PDCCH repetition, and the first occasion of the SS set i is linked with a third occasion of the SS set k including no SBFD symbol.

Clause 33. The network device of clause 32, wherein the processor is further configured to at least one of the following: skip transmitting the PDCCH in the third occasion of the SS set k; skip transmitting the PDCCH in the SS set k in the first slot; or skip transmitting the PDCCH in the SS set k in a PDCCH candidate without a linked PDCCH candidate in the SS set i.

Clause 34. The network device of clause 32, wherein the processor is further configured to at least one of the following: transmit, as a single PDCCH transmission without the PDCCH repetition, the PDCCH in the third occasion of the SS set k; transmit, as a single PDCCH transmission without the PDCCH repetition, the PDCCH in the SS set k in the first slot; or transmit, as a single PDCCH transmission without the PDCCH repetition, the PDCCH in the SS set k in a PDCCH candidate without a linked PDCCH candidate repetition in the SS set i.

Clause 35. The network device of clause 20, wherein the processor is further configured to: transmit, to the network device, signaling indicating occasions of one or more SS sets, wherein none of the occasions of the one or more SS set is overlapped with both an SBFD symbol and a non-SBFD symbol.

Clause 36. The network device of clause 20, wherein the processor is further configured to: transmit, to the network device, signaling indicating occasions of one or more SS sets; and in the case that a fourth occasion in an SS set h among the one or more SS set is overlapped with both an SBFD symbol and a non-SBFD symbol, skip transmitting the PDCCH in the fourth occasion of the SS set h or skip transmitting the PDCCH in the SS set h in the slot including the fourth occasion.

Clause 37. A method performed by a terminal device, comprising: monitoring, via the transceiver and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

Clause 38. A method performed by a network device, comprising: transmitting, via the transceiver to a terminal device and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

Clause 39. A non-transitory computer readable medium having instructions stored thereon, the instructions, when executed by a processor of an apparatus, causing the apparatus to perform at least the method of clause 37 or 38.

Clause 40. A computer program product comprising instructions, which, when executed by a processor of an apparatus, causing the apparatus to perform at least the method of clause 37 or 38.

What is claimed is:

1. A user equipment (UE) for wireless communication, comprising:
at least one memory; and
at least one processor coupled with the at least one memory and operable to cause the UE to:
monitor, according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

2. The UE of claim 1, wherein an associated control resource set (CORESET) of the SS set i is outside a downlink (DL) subband or overlapped with an uplink (UL) subband.

3. The UE of claim 1, wherein the at least one processor is further operable to cause the UE to:
determine a SS set j linked with the SS set i, wherein the SS set j is used for monitoring the PDCCH in one or more occasions or slots including the SBFD symbol, and the first set of parameters is parameters of the SS set j.

4. The UE of claim 1, wherein the at least one processor is further operable to cause the UE to:
determine one or more dedicated SS set j for monitoring the PDCCH in one or more occasions or slots including the SBFD symbol, wherein the first set of parameters is parameters of the SS set j.

5. The UE of claim 1, wherein at least one of:
for an aggregation level (AL) of the PDCCH, the first set of parameters comprises a first number of PDCCH candidates for an SBFD symbol or slot, and the second set of parameter comprises a second number of PDCCH candidates for a non-SBFD symbol or slot; or
the first set of parameters comprises a first AL and a corresponding first number of PDCCH candidates for an SBFD symbol or slot, the second set of parameter comprises a second AL and a corresponding second number of PDCCH candidates for a non-SBFD symbol or slot.

6. The UE of claim 5, wherein the first number of PDCCH candidates for an SBFD symbol or slot is determined based on at least one of:
a higher layer signaling from a network device; or
the second number of PDCCH candidates, a number of control channel elements (CCEs) detected in the first occasion or in the first slot, and the second AL.

7. The UE of claim 1, wherein the 24 first set of parameters comprises at least one of:
a first number of control channel elements (CCEs) without a resource element group (REG) outside a DL downlink (DL) subband or overlapped with an uplink (UL) subband for a PDCCH candidate in the occasion; or
a second number of CCEs that is biggest one from {1,2,4,8,16} and equal to or smaller than the first number of CCEs.

8. The UE of claim 1, wherein a SS set k is linked with the SS set i for a PDCCH repetition, and the first occasion of the SS set i is linked with a third occasion of the SS set k including no SBFD symbol.

9. The UE of claim 8, wherein the at least one processor is operable to cause the UE to:
skip monitoring the PDCCH in the third occasion of the SS set k;
skip monitoring the PDCCH in the SS set k in the first slot; or
skip monitoring the PDCCH in the SS set k in a PDCCH candidate without a linked PDCCH candidate in the SS set i.

10. The UE of claim 8, wherein the at least one processor is operable to cause the UE to:
monitor, as a single PDCCH transmission without the PDCCH repetition, the PDCCH in the third occasion of the SS set k;
monitor, as a single PDCCH transmission without the PDCCH repetition, the PDCCH in the SS set k in the first slot; or
monitor, as a single PDCCH transmission without the PDCCH repetition, the PDCCH in the SS set k in a PDCCH candidate without a linked PDCCH candidate repetition in the SS set i.

11. The UE of claim 8, wherein the the at least one processor is operable to cause the UE to:
skip monitoring the PDCCH in the SS set i in the first occasion;
monitor the PDCCH in the third occasion of the SS set k; and
process the PDCCH assuming that a PDCCH candidate in the third occasion of the SS set k has a linked PDCCH candidate repetition in the first occasion.

12. The UE of claim 1, wherein the at least one processor is operable to cause the UE to:
receive signaling indicating occasions of one or more SS sets, wherein none of the occasions of the one or more SS set is overlapped with both an SBFD symbol and a non-SBFD symbol.

13. The UE of claim 1, wherein the at least one processor is operable to cause the UE to:
receive signaling indicating occasions of one or more SS sets; and
in a case that a fourth occasion in an SS set h among the one or more SS set is overlapped with both an SBFD symbol and a non-SBFD symbol, skip monitoring the PDCCH in the fourth occasion of the SS set h or skip monitoring the PDCCH in the SS set h in the slot including the fourth occasion.

14. A network device for wireless communication, comprising:
at least one memory; and
at least one processor coupled with the at least one memory and operable to cause the network device to:
transmit, to a user equipment (UE) and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

15. A method performed by user equipment (UE), the method comprising:
monitoring, according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.

16. The method of claim 15, wherein an associated control resource set (CORESET) of the SS set i is outside a downlink (DL) subband or overlapped with an uplink (UL) subband.

17. The method of claim 15, further comprising:
determining a SS set j linked with the SS set i, wherein the SS set j is used for monitoring the PDCCH in one or more occasions or slots including the SBFD symbol, and the first set of parameters is parameters of the SS set j.

18. The method of claim 15, further comprising:
determining one or more dedicated SS set j for monitoring the PDCCH in one or more occasions or slots including the SBFD symbol, wherein the first set of parameters is parameters of the SS set j.

19. The method of claim 15, comprising one or more of:
for an aggregation level (AL) of the PDCCH, the first set of parameters comprises a first number of PDCCH candidates for an SBFD symbol or slot, and the second set of parameter comprises a second number of PDCCH candidates for a non-SBFD symbol or slot; or
the first set of parameters comprises a first AL and a corresponding first number of PDCCH candidates for an SBFD symbol or slot, the second set of parameter comprises a second AL and a corresponding second number of PDCCH candidates for a non-SBFD symbol or slot.

20. A method performed by a network device, the method comprising:
transmitting, to a user equipment (UE) and according to a first set of parameters, a physical downlink control channel (PDCCH) in a first occasion of a search space (SS) set i or in a first slot including the first occasion, wherein the first occasion includes a sub-band full duplex (SBFD) symbol, and the first set of parameters is associated with the SS set i and is different from a second set of parameters of the SS set i.
